(19) United States
(12) Patent Application Publication
(10) Pub. No.: US 2024/0311404 A1
(43) Pub. Date: Sep. 19, 2024

(54) SYSTEM AND METHOD FOR NATURAL LANGUAGE CONVERSATIONAL AI

(71) Applicant: VESTI.AI LTD., Havant Hampshire (GB)

(72) Inventors: Jonty HURWITZ, Steep (GB); Deborah YANG, Paris (FR); Jeffrey GINSBERG, Stanmore (GB); Jonathan BURN, Meldreth (GB)

(21) Appl. No.: 18/280,243

(22) PCT Filed: Mar. 3, 2022
(86) PCT No.: PCT/EP2022/055408

§ 371 Date: Sep. 4, 2023

Related U.S. Application Data
(60) Provisional application No. 63/155,763, filed on Mar. 3, 2021.

(51) Int. Cl. G06F 16/332; G06Q 40/06

(52) U.S. Cl. CPC G06F 16/3329; G06F 16/3328; G06Q 40/06

(57) ABSTRACT

A non-transitory computer readable medium containing instructions that when executed by at least one processor, cause the at least one processor to perform operations for generating a conversational presentation, the operations including: providing for display on a graphical user interface (GUI), a query playlist of a series of queries and related responses; displaying on the GUI the series of queries and related responses arranged in a scrollable vertical and horizontal display and a query entry box, wherein each query is displayed in a query header and each related response is displayed in an adjacent response area; and where a user query is entered by a user in the query entry box, pausing or stopping the query playlist, displaying the user query in the query header, and displaying a response to the user query in the response area.

### CROSS-REFERENCE TO RELATED APPLICATIONS

This application is based on and claims benefit of priority of U.S. Provisional Patent Application No. 63/155,763, filed Mar. 3, 2021, the contents of which are incorporated herein by reference in its entirety.

### BACKGROUND

Conversational artificial intelligence (AI) is a set of technologies enabling automated messaging and speech-enabled applications in order to provide human-like interactions between computers and humans. Conversational AI technologies provide for recognizing speech and text inputs provided by a human, understanding the intent of the recognized input, and responding in a way that mimics human conversation. Ideally the conversational AI system uses machine learning techniques to evolve from every human interaction to thereby improve the ability of the system to recognize input and intent and provide relevant responses.

Current conversational computing systems may be limited by the willingness of users to send queries to the system. Often users don't know what queries can be successfully answered (or are disappointed by previous incorrect responses) and therefore may fail to fully explore the capabilities of the system. Further, the lack of queries may impede the training of the system since less material is provided that the system could learn from.

Current conversational AI systems further may suffer from a very linear nature, with the AI merely responding to the input of a user and not encouraging further interaction or leading the user to explore further capabilities of the system.

Current conversational computing systems further may not offer a way to maintain a history of questions asked in a way that does not involve re-asking the questions, particularly questions whose answers can change with relatively high frequency. Alternatively, viewing updated answers to questions without having to re-ask them may require clicking on stored URLs or constantly refreshing open pages. Thus, in current conversational interfaces, users may not be able to see updated answers to historical questions automatically when they return to the system.

Current conversational computing systems further may not offer a way to favorite questions so that when the user returns at a later date, they are able to automatically see the latest answers to their favorited questions.

The above limitations are magnified in attempts to provide financial data in the form of conversational AI. Many users are not sufficiently familiar with investment terminology and thus may not be able to exploit the investment-related conversational AI beyond very basic queries. Further, such users may be unaware of important financial indicators and thus may not know which of these indicators are worth viewing or analyzing.

For many inexperienced investors a further issue is understanding financial markets and the position or risk of the investor portfolio relative to the market. High quality institutional grade performance, risk, and ESG (environmental, social, and corporate governance) analytics may be available to investors working with dedicated asset management firms. These analytics may therefore not be available in conversational AI systems aimed at inexperienced investors.

### SUMMARY

This disclosure presents various mechanisms for conversational AI systems. Aspects of this disclosure may be used to provide conversational AI based applications for a range of fields including but not limited to financial and investment information and advice. Aspects of this disclosure provide for multiple features to encourage user interaction, expose users to the full capabilities of the system, and thus enhance the ability of the system to continually be trained to provide improved responses. For example, features of the conversational AI system described herein may include:

The conversation interface may continually suggest system-generated queries from a playlist of queries (referred to herein as a “query playlist”) in a scrollable format familiar to users—even if users do not post any queries themselves. This approach encourages exploration of the system capabilities as users get to see the sorts of queries that the system can handle as well as queries that may be useful;
Continual AI learning from queries posted by users as well as user reaction to the provided responses to thereby increase the scope of queries the system can handle as well as the effectiveness of the generated responses;
Users favoriting (or un-favoriting) queries and their responses, informs the system which queries/responses to automatically show the user on their next visit;
Responses are generated by a combination of text and an infographic service combining text, images, graphs, videos, and graphic elements so that they are visually engaging and make the response easy to understand;
Queries and responses may include detailed financial performance, risk, and ESG analytics presented in novel formats with descriptive text making the analytics accessible and understandable to the inexperienced investors.

The term “query” as used herein indicates a textual message (that may originate as a voice message converted to text) posted to the conversational AI system or a textual content query or header that forms part of a predefined playlist. While the term “query” is used, it should be appreciated that a user may also issue instructions or responses to questions asked by the system and the term query covers such actions as well. A query may alternatively be referred to herein as a content header or simply “header”. The term playlist as used herein refers to a list of queries, either provided by a user or defined by a playlist administrator or being a combination of these and stored in a central server and/or on a user device. In use, a playlist is displayed by a GUI of the disclosed system as a series of queries/headers each followed by response content to the query, where the response content may be defined by a playlist administrator or generated dynamically. A playlist administrator may be a human operator of the systems described herein. In non-limiting examples provided herein the queries may relate to financial information. As used herein “real-time” or “dynamic” responses to queries are responses that are not predetermined and formed from current data, where current data (exemplarily, current financial market data that is typically constantly updated) is retrieved in response to the query and the response is determined and constructed according to the retrieved current data, where current data may exemplarily be updated every second, minute, or hour.

Consistent with disclosed embodiments, a non-transitory computer readable medium may contain instructions that when executed by at least one processor, cause the at least one processor to perform operations for generating a conversational presentation, the operations including: providing for display on a graphical user interface (GUI), a query playlist of a series of queries and related responses; displaying on the GUI the series of queries and related responses arranged in a scrollable vertical and horizontal display and a query entry box, wherein each query is displayed in a query header and each related response is displayed in an adjacent response area; and where a natural language conversational user query is entered by a user in the query entry box, pausing or stopping the query playlist, displaying the user query in the query header, and displaying a response to the user query in the response area.

In some embodiments, the operations further include performing speech recognition and natural language processing of the user query to extract at least one of a user intent, a context, and a time period; and providing the response to the user query based on analysis of the at least one of user intent, context, and time period. In some embodiments, the operations further include resuming display of a resumed playlist following display of the response to the user query wherein the resumed playlist is adapted to user interests following machine learning based analysis of the user query.

In some embodiments, the operations further include resuming display of a resumed playlist following display of the response to the user query wherein the resumed playlist includes suggestions for other playlists that may interest the user following machine learning based analysis of the user query. In some embodiments, the at least one processor is further configured to generate of graphical representation as part of a response to a query for presentation in the GUI.

In some embodiments, the operations further include in response to a user selecting a topic of interest, providing the query playlist, wherein the query playlist includes related responses adapted to the topic of interest. In some embodiments, the operations further include in response to a user selecting a query playlist from a catalogue of query playlists, providing the selected query playlist, wherein the selected query playlist includes predefined responses or real-time responses.

In some embodiments, the operations further include performing machine learning based analysis of user selection of topics or playlists or a user investment portfolio and displaying via the GUI suggestions for other playlists that may interest the user. In some embodiments, the queries relate to financial market data and include ESG (environmental, social, and corporate governance), social media sentiment, social media activity, alignment with UN sustainable development goals, corporate nutrition facts, and a morality scorecard.

In some embodiments, the queries include a nutrition card, and the related response includes an infographic including financial data related to a company or business, wherein the infographic is configured to mimic the layout and look and feel of a food nutrition label. In some embodiments, the at least one processor is further configured to prepare the related responses in real time.

Consistent with disclosed embodiments, a method for generating a conversational presentation includes: providing for display on a graphical user interface (GUI), a query playlist of a series of queries and related responses; displaying on the GUI the series of queries and related responses arranged in a scrollable vertical and horizontal display and a query entry box, wherein each query is displayed in a query header and each related response is displayed in an adjacent response area; and where a user query is entered by a user in the query entry box, pausing or stopping the query playlist, displaying the user query in the query header, and displaying a response to the user query in the response area.

In some embodiments, the method further includes performing speech recognition and natural language processing of the user query to extract at least one of a user intent, a context, and a time period; and providing the response to the user query based on analysis of the at least one of user intent, context, and time period. In some embodiments, the method further includes resuming display of a resumed playlist following display of the response to the user query wherein the resumed playlist is adapted to user interests following machine learning based analysis of the user query.

In some embodiments, the method further includes resuming display of a resumed playlist following display of the response to the user query wherein the resumed playlist includes suggestions for other playlists that may interest the user following machine learning based analysis of the user query. In some embodiments, the at least one processor is further configured to generate of graphical representation as part of a response to a query for presentation in the GUI.

In some embodiments, the method further includes in response to a user selecting a topic of interest, providing the query playlist, wherein the query playlist includes related responses adapted to the topic of interest. In some embodiments, the method further includes in response to a user selecting a query playlist from a catalogue of query playlists, providing the selected query playlist, wherein the selected query playlist includes predefined responses or real-time responses.

In some embodiments, the method further includes performing machine learning based analysis of user selection of topics or playlists or a user investment portfolio and displaying via the GUI suggestions for other playlists that may interest the user. In some embodiments, the queries relate to financial market data and include ESG (environmental, social, and corporate governance), social media sentiment, social media activity, alignment with UN sustainable development goals, corporate nutrition facts, and a morality scorecard.

In some embodiments, the queries include a nutrition card, and the related response includes an infographic including financial data related to a company or business, wherein the infographic is configured to mimic the layout and look and feel of a food nutrition label. In some embodiments, the at least one processor is further configured to prepare the related responses in real time.

Consistent with disclosed embodiments, a system includes at least one processor configured to: provide for display on a graphical user interface (GUI), a query playlist of a series of queries and related responses; display on the GUI the series of queries and related responses arranged in a scrollable vertical and horizontal display and a query entry box, wherein each query is displayed in a query header and each related response is displayed in an adjacent response area; and where a user query is entered by a user in the query entry box, to pause or stop the query playlist, display the user query in the query header, and display a response to the user query in the response area.

In some embodiments, the system is further configured to perform speech recognition and natural language processing of the user query to extract at least one of a user intent, a context, and a time period; and to provide the response to the user query based on analysis of the at least one of user intent, context, and time period. In some embodiments, the system is further configured to resume display of a resumed playlist following display of the response to the user query wherein the resumed playlist is adapted to user interests following machine learning based analysis of the user query.

In some embodiments, the system is further configured to resume display of a resumed playlist following display of the response to the user query wherein the resumed playlist includes suggestions for other playlists that may interest the user following machine learning based analysis of the user query. In some embodiments, the system is further configured to generate a graphical representation as part of a response to a query for presentation in the GUI.

In some embodiments, the system is further configured, in response to a user selecting a topic of interest, to provide the query playlist, wherein the query playlist includes related responses adapted to the topic of interest. In some embodiments, the system is further configured, in response to a user selecting a query playlist from a catalogue of query playlists, to provide the selected query playlist, wherein the selected query playlist includes predefined responses or real-time responses.

In some embodiments, the system is further configured to perform machine learning based analysis of user selection of topics or playlists or a user investment portfolio and displaying via the GUI suggestions for other playlists that may interest the user. In some embodiments, the queries relate to financial market data and include ESG (environmental, social, and corporate governance), social media sentiment, social media activity, alignment with UN sustainable development goals, corporate nutrition facts, and a morality scorecard. In some embodiments, the queries include a nutrition card, and the related response includes an infographic including financial data related to a company or business, wherein the infographic is configured to mimic the layout and look and feel of a food nutrition label. In some embodiments, the at least one processor is further configured to prepare the related responses in real time.

Consistent with disclosed embodiments, a machine readable non-transitory storage medium includes instructions stored thereon, wherein the instructions, when executed by at least one processor, cause the at least one processor to perform operations include: displaying an infographic in a graphical user interface, the infographic including financial data related to a company or business, wherein the infographic is configured to mimic the layout and look and feel of a food nutrition label.

Various embodiments are described herein with reference to a system, method, device, or computer readable medium. It is intended that the disclosure of one is a disclosure for all. For example, it is to be understood that disclosure of a computer readable medium described herein also constitutes a disclosure of methods implemented by the computer readable medium, and systems and devices for implementing those methods, via for example at least one processor. It is to be understood that this form of disclosure is for each of discussion only, and one or more aspects of one-embodiment herein may be combined with one or more aspects of other embodiments herein, within the intended scope of this disclosure

This Summary is provided to introduce a selection of concepts in a simplified form that are further described below in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A illustrates a system for providing natural language based conversational AI consistent with some embodiments of this disclosure.

FIGS. 1B-1C are block diagrams of user device implementations consistent with some embodiments of this disclosure.

FIGS. 2A-2C illustrate example graphical user interfaces for displaying a natural language conversational AI view consistent with some embodiments of this disclosure.

FIG. 3A is a diagram illustrating a query playlist consistent with some embodiments of this disclosure.

FIG. 3B is a diagram illustrating a query playlist flow consistent with some embodiments of this disclosure.

FIGS. 3C and 3D illustrate example graphical user interfaces for displaying a query playlist catalogue consistent with some embodiments of this disclosure.

FIG. 4A is a diagram of an example process for displaying a natural language conversational view consistent with some embodiments of this disclosure.

FIGS. 4B-4J illustrates example graphical user interfaces for displaying a natural language conversational view consistent with some embodiments of this disclosure.

FIG. 5 illustrates an example graphical user interface for characterizing financial data consistent with some embodiments of this disclosure.

FIGS. 6A-6C illustrate an example graphical user interface for characterizing financial data consistent with some embodiments of this disclosure.

FIGS. 7A-7C illustrate an example graphical user interface for characterizing financial data consistent with some embodiments of this disclosure.

FIG. 8A is a diagram of an example process for displaying a playlist view consistent with some embodiments of this disclosure.

FIGS. 8B-8G illustrate example graphical user interfaces for selecting and displaying playlist views consistent with some embodiments of this disclosure.

### DETAILED DESCRIPTION

Reference will now be made in detail to non-limiting examples of conversational AI implementations which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

Aspects of this disclosure may provide a technical solution to the challenging technical problem of functional conversational AI and may relate to a system for providing natural language based conversational AI applications with the system having at least one processor (e.g., processor, processing circuit or other processing structure described herein), including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

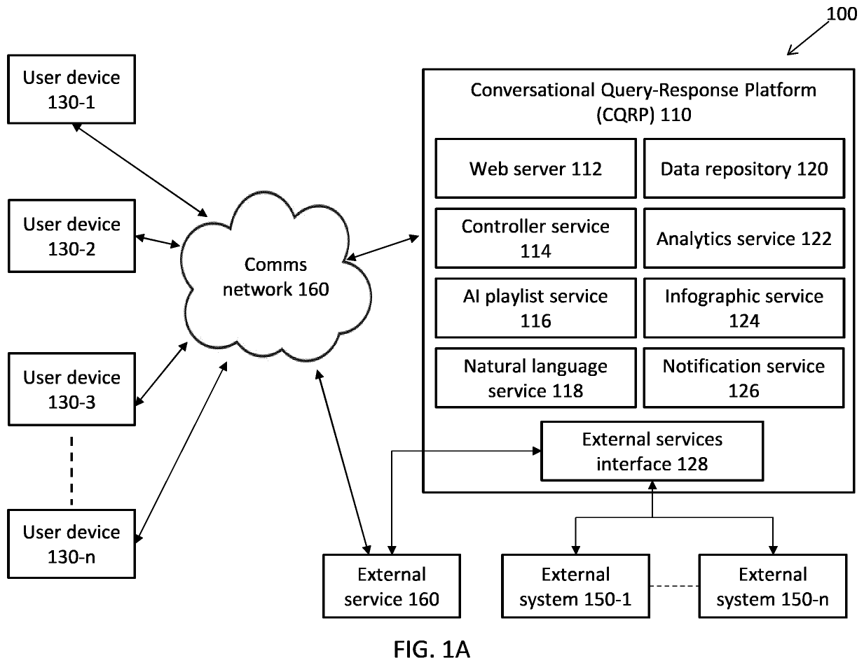

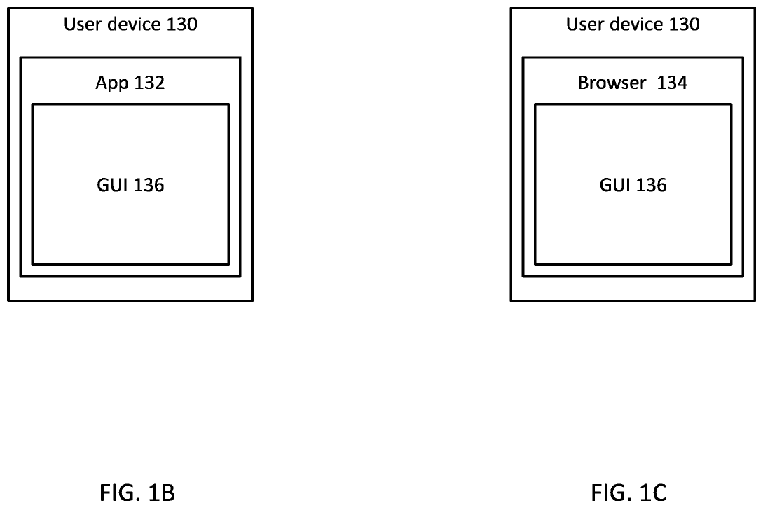

FIG. 1A illustrates a system 100 for providing natural language based conversational AI consistent with some embodiments of this disclosure. In system 100, users and external services interact with a conversational query-response platform (CQRP) 110 using user devices 130-1, 130-2, 130-3 to 130-n through communications network 130 using wired or wireless communication. Communications network 160 may include a wide variety of network configurations and protocols that facilitate the intercommunication of computing devices. For example, each of the components of system 100 in FIG. 1A can be implemented in a localized or distributed fashion in a network.

CQRP 110 and the modules and components that are included in CQRP 110 may include a non-transitory computer readable medium containing instructions that when executed by at least one processor are configured to perform the functions and/or operations necessary to provide the functionality described herein. While CQRP 110 is presented herein with specific components and modules, it should be understood by one skilled in the art, that the architectural configuration of system 100 as shown may be simply one possible configuration and that other configurations with more or fewer components are possible. As referred to herein, the “components” of CQRP 110 may include one or more of the modules or services shown in FIG. 1A as being included within CQRP 110.

A user device 130 may include a non-transitory computer readable medium containing instructions that when executed by at least one processor are configured to perform user device functionality as described herein. User devices 130 can be of varying type, capabilities, operating systems, etc. For example, user devices 130 may include PCs, tablets, mobile phones, laptops, virtual reality or augmented reality glasses or other wearables, holographic interfaces, or any other mechanism that allows for user interaction with the platform. Furthermore, CQRP 110 can concurrently accept connections from and interact with multiple user devices 130. A single user may interact with CQRP 110 using multiple different user devices 130.

CQRP 110 may include a controller service 114. Controller service 114 may manage the operation of the components of CQRP 110 and may direct the flow of data between the components of CQRP 110 and also the conversation flow for user interaction with CQRP 110. Where CQRP 110 may be said herein to provide specific functionality or perform actions, it should be understood that the functionality or actions are performed by controller service 114 that may call on other components of CQRP 110 and/or external systems 150 and/or external services 160. For example, controller service 114 may receive queries from the users and call on other components of CQRP to deliver content in response. Controller service 114 may also manage user sign on and user data. One or more human “system administrators” (herein “system admin” or simply “admin” or “playlist administrators”) may interact with CQRP 110 using an administrator interface (not shown) for configuring aspects of CQRP 110.

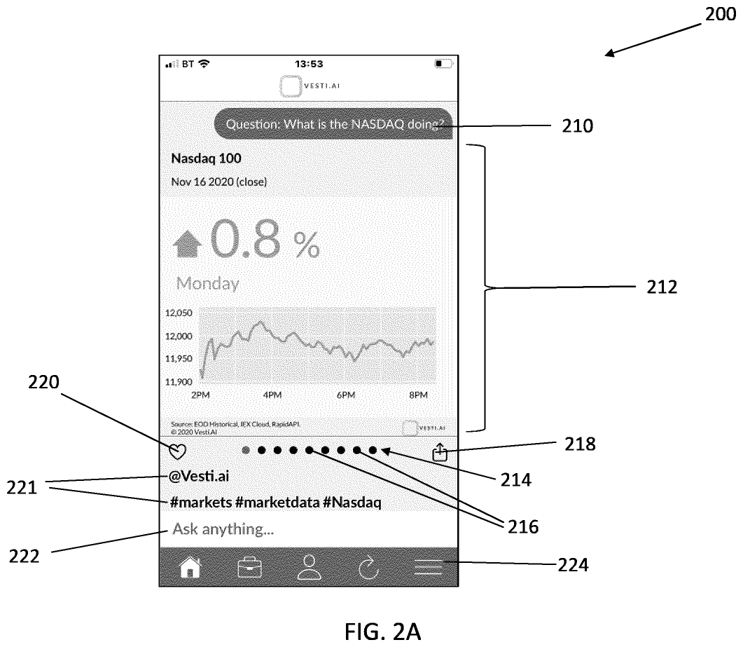

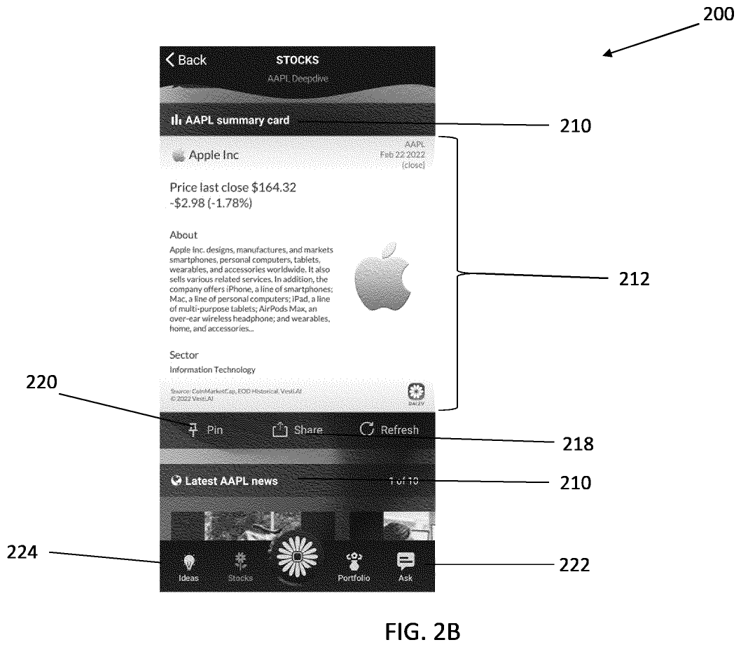

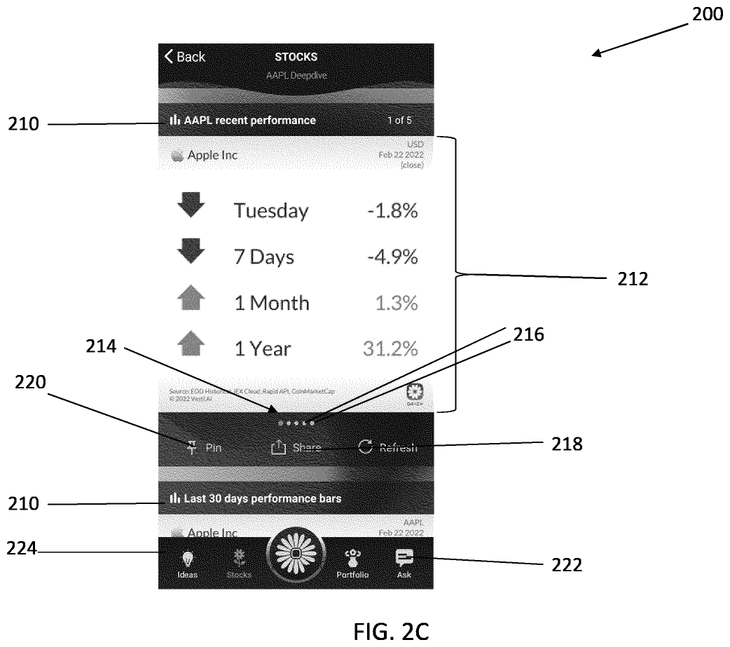

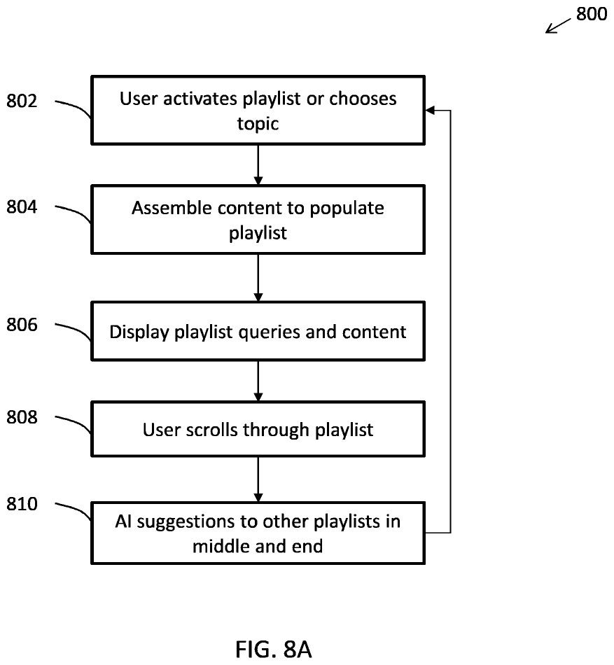

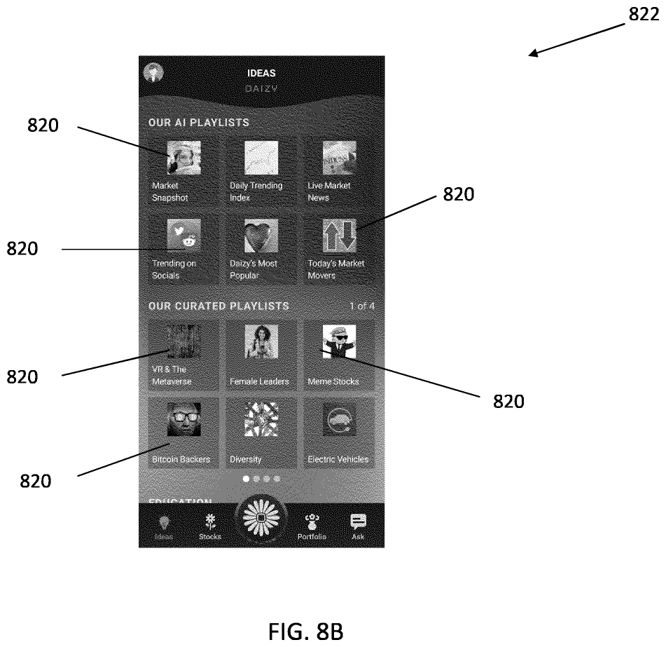

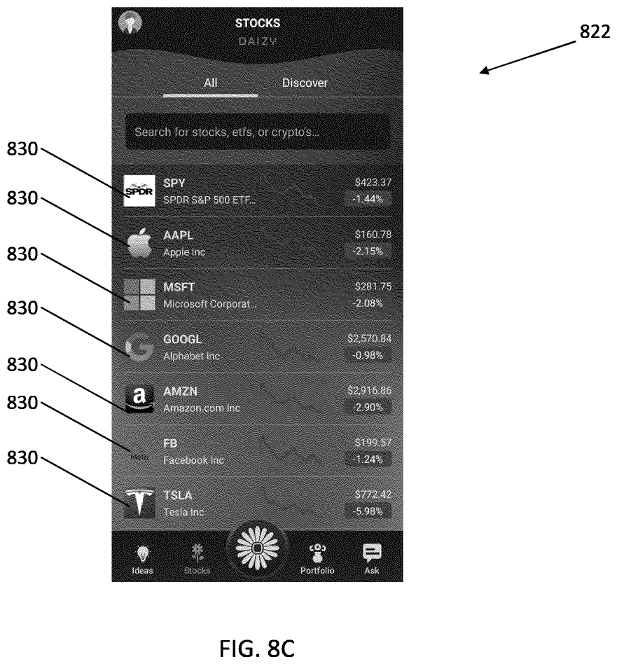

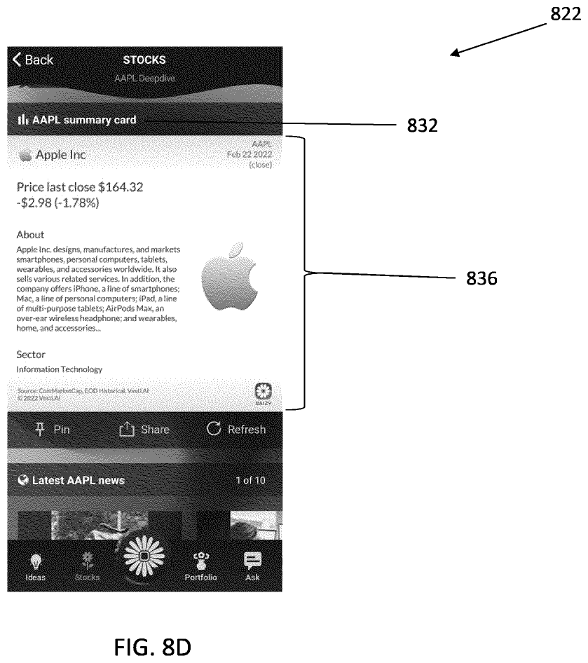

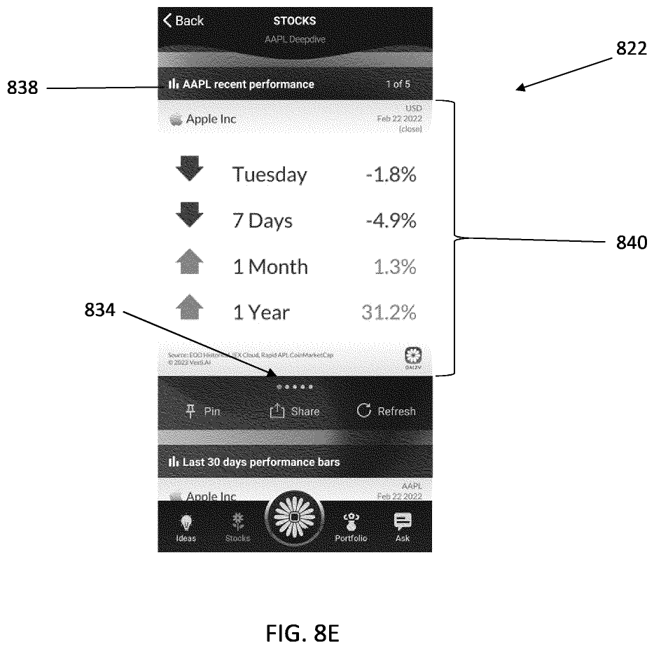

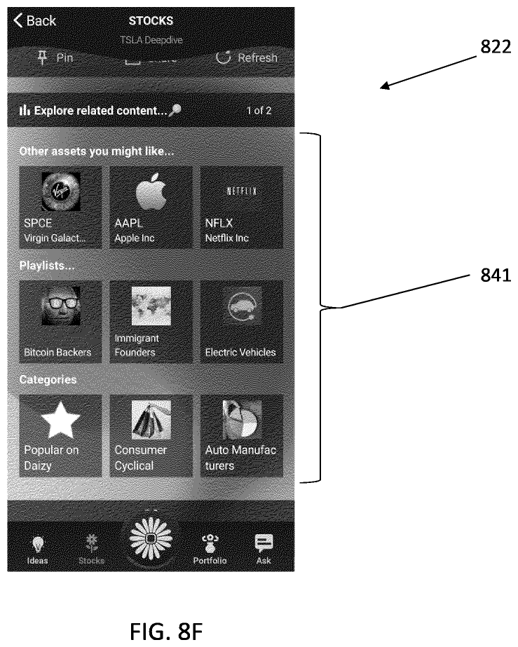

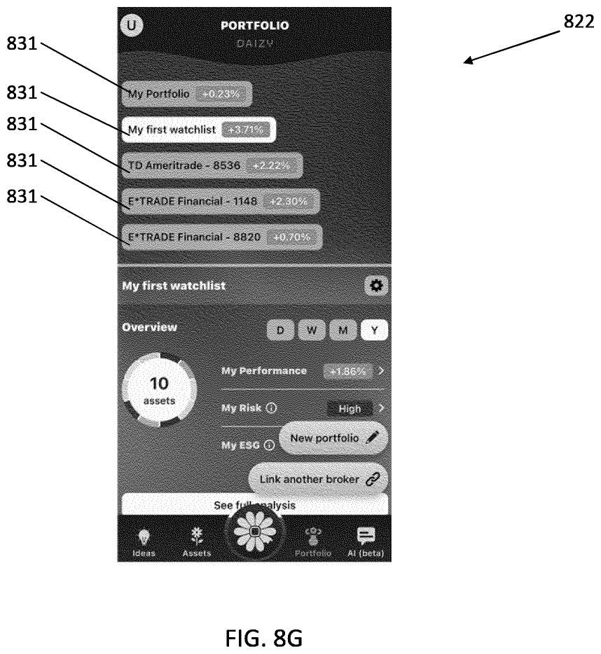

CQRP 110 may include an AI playlist service 116. AI playlist service 116 may use machine learning techniques to analyze queries asked by users to then further train AI playlist service 116 to better anticipate the queries that users may ask. CQRP 110 may also be informed by the user indicating the like or dislike of a query with some kind of indicative icon, though not specifically the icon shown in GUI 200 (FIGS. 2A-2C) below. Where users have not asked queries, AI playlist service 116 may generate queries, query playlists, and provide responses (using other components of CQRP 110 as required) and provides these to the user to thereby encourage usage of the system and educate the user about the range of queries that can be posed to CQRP 110. AI playlist service 116 may further analyze user data (such as the user investment portfolio) and user behavior while interacting with CQRP 110 such as but not limited to browsing time, shares, likes and so forth to better adapt the queries and query playlists presented to a user. In some embodiments a playlist including a defined set of queries may be defined by an admin. In some embodiments AI playlist service 116 may populate fixed playlists with response content related to a specific topic selected by a user such as described with reference to FIGS. 8C-8E.

CQRP 110 may include a natural language service 118. Natural language service 118 may use machine learning techniques for providing automatic speech recognition (ASR) and natural language processing (NLP). Natural language service 118 may recognize speech and text queries provided by a user, admin, or external service 160. Natural language service 118 may further deconstruct the recognized query text to extract intent, context, and also time period (where appropriate). In a non-limiting example, a user might provide a financial query “what was my exposure to tech last week?”. Natural language service 118 may break down the query as follows: The word “my” relates to a portfolio including stocks held or watched by the user; the word “exposure” implies the user's asset allocation; the word “tech” refers to technology related holdings; and the phrase “last week” provides a timeframe that constrains the query.

CQRP 110 may include an analytics service 122. Analytics service 122 uses the extracted user intent, context, and time period from natural language service 118 to provide the required data that will be needed to create the response to the user query. Referring again to the non-limiting example above (“what was my exposure to tech last week?”), analytics service 122 will retrieve the list of stocks in the user portfolio, obtain real-time price information and perform the necessary calculations such as the asset allocation over the indicated timeframe to provide an analytics result. Analytics service 122 may retrieve data from external systems 150-1 . . . 150-n via external services interface 128. For example, real-time stock price information may be retrieved from external systems 150.

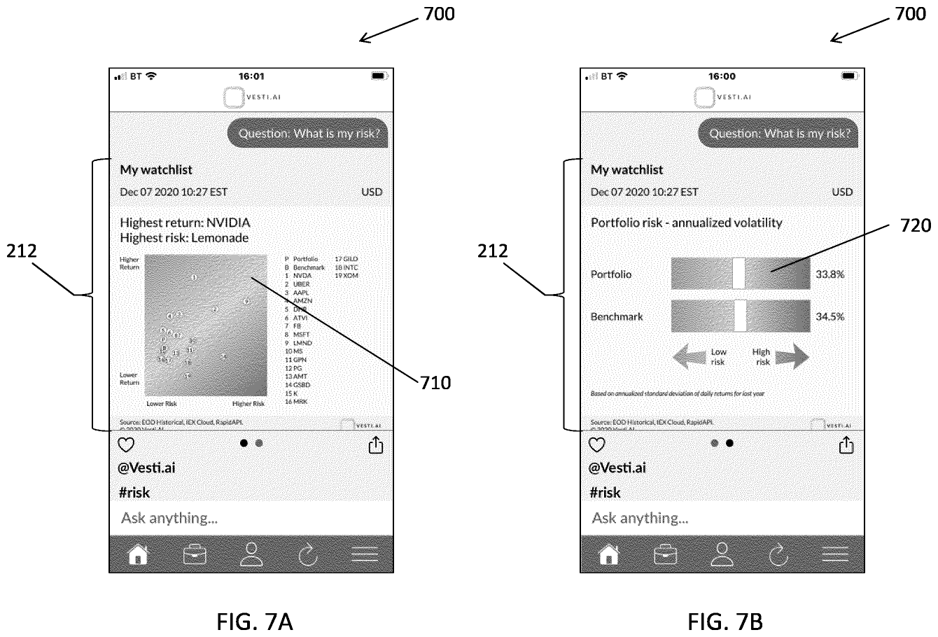

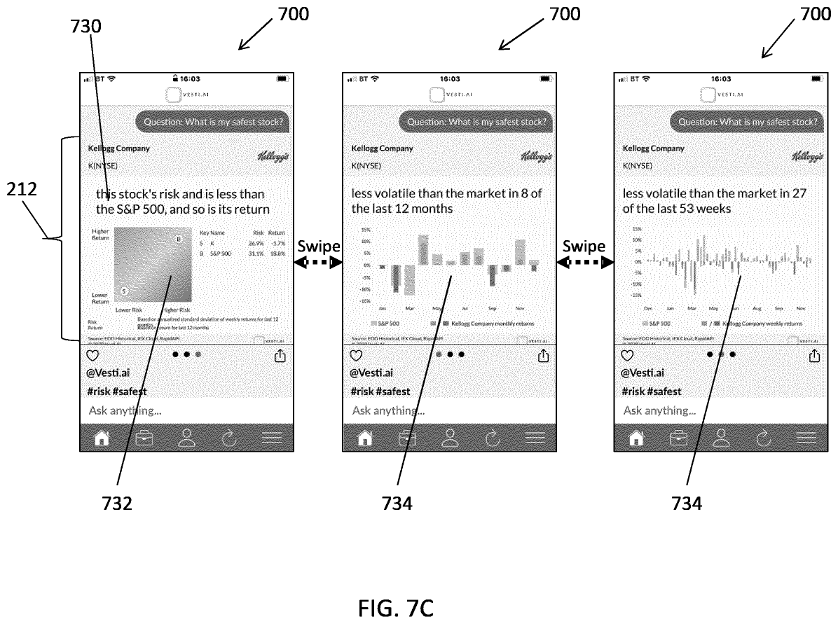

CQRP 110 may include an infographic service 124. Infographic service 124 uses the analytics result of the analytics service 122 to generate engaging graphical representations of the analytics result that can be presented to the user in response to queries as response content. In some embodiments, the generated response content from infographic service 124 may be based on a template. For example, as shown in FIG. 7A, GUI 700 is based on a template that includes a colored gradient square 710 with the portfolio stocks mapped onto the square to visually indicate the relative risk of each stock as well as related textual information presented around the square. In use, infographic service 124 may populate the template with updated information received from analytics service 122.

CQRP 110 may include a notification service 126 for notifying users of events related to user queries, user portfolio or social media related alerts such as likes and shares. Notification service may notify users through app 132 (FIG. 1B), browser 134 (FIG. 1C) or through other messaging services.

CQRP 110 may include a data repository 120. Although data repository 120 is shown as a single entity, in practice data repository 120 may include one or more databases. Data repository stores data required for the functioning of CQRP 110.

CQRP 110 may include a web server 112 to support connections from a variety of different user devices 130, such as: desktop computers; mobile computers; mobile communications devices, e.g., mobile phones, smartphones, tablets; and/or any other network enabled computing devices. In some implementations, user device 130 interaction with CQRP 110 may be with web server 112. In some implementations, user device 130 interaction with CQRP 110 may be with other components of CQRP 110 such as AI playlist service 116 or infographic service 124 where generated images may be available at specific URLs.

In some implementations, CQRP 110 may include an external services interface (API) 128 for interfacing with various external services and systems 150-1, 150-2, to 150-n such as for retrieving real time or other data related to queries and/or for enabling users to manage portfolios (such as but not limited to buying and selling financial instruments) that are monitored on system 100. In some embodiments, external service interface 128 can provide an interface into CQRP 110 for one or more of external service 160 where one or more user devices 130 access some or all of the features of CQRP 110 via external service 160 and not through CQRP 110 directly. External service 160 may thus provide a similar user experience as for direct users of CQRP 110 but with the branding of the external service 160. Alternatively, external service 160 may use the functionality of CQRP 110 via external services interface 128 to retrieve responses to questions asked by users of external service 160 where responses may include the same textual, graphic, image and video content provided to direct users of CQRP 100. In some implementations, CQRP 110 would store user data for users of external service 160 so as to personalize queries and responses per user of external service 160.

In some implementations, CQRP 110 may include a sharing module (not shown) for managing sharing of content provided by CQRP 110 publicly or privately. Alternatively, the sharing of content may be handled by the sharing functionality of user device 130.

In some embodiments, such as shown in FIG. 1B, a user using user device 130 can interact with CQRP 110 or external service 160 via an application (app) 132 installed on user device 130. App 132 may be a stand-alone application, one or more application plug-ins, and/or a browser extension. App 132 may be a dedicated app having a GUI such as GUI 200 described below or may be a messaging app for interacting with CQRP 110.

In some implementations, such as shown in FIG. 1C, a user device 130 can interact with CQRP 110 or external service 160 via a third-party application, such as a web browser 134 running on user device 130. For example, the user can navigate in web browser 134 to a web address provided by CQRP 110 for interacting with CQRP 110 or a web address provided by external service 160 for interacting with external service 160. It should be appreciated that some devices 130 may support both of an app 132 and a web browser 134. FIGS. 1B and 1C show separate implementations for simplicity.

Either of app 132 or browser 134 may provide a graphical user interface (GUI) 136 for the user to interact with CQRP 110 or external service 160. References herein to a GUI 136 and to views of GUI 136 should be understood as referring to the GUI 136 generated by app 132 or browser 134 based on the data provided by the components of CQRP 110 or app 132 or browser 134. Interaction with GUI 136 may include viewing or selecting graphical elements using the interface hardware of user devices 130 including but not limited to a touchscreen, 2D or 3D display, mouse, keyboard and so forth.

FIGS. 2A-2C illustrate example graphical user interfaces for displaying a natural language conversational AI view consistent with some embodiments of this disclosure. A non-transitory computer readable medium may contain instructions that when executed by at least one processor, for example, app 132 or browser 134, may generate GUI 200 based on data provided, generated or stored in CQRP 110 and/or on device 130 for display on user device 130 in response to the user posting a natural language conversational query such as displayed in query header 210 or in response to a user accessing GUI 200 such as by opening app 132 or accessing a website associated with GUI 200 via browser 134 or in response to a user choosing to open a query playlist by interaction with GUI 200, where the playlist queries may be interspersed with fixed or dynamic responses.

In some embodiments, queries, responses, playlists, and other information discussed in connection with FIGS. 2A-2C, 3A-3D, 4A-4J, 5, 6A-6C, 7A-7C and 8A-8F may be presented as graphical elements by a non-transitory computer readable medium containing instructions that may be executed by at least one processor. The presentation may occur via a display associated with user device 130 based on data provided by CQRP and formed into a graphical presentation by software (132, 134) and hardware of user device 130 and interaction of the user may include selecting, swiping, scrolling, and otherwise interacting with graphic elements on the display such as by using interaction capabilities of the user device including a touch screen, keyboard, mouse, and so forth.

In some implementations, GUI 200 may include graphical elements including one or more of:
a query header 210 showing (FIG. 2A) a textual natural language conversational query posted by a user or generated by CQRP 110, or showing (FIGS. 2B, 2C) a query header 210 that forms part of a playlist;
a response area 212 displaying response content generated by CQRP 110 to the query shown in the adjacent query header 210 above the response, the response content featuring any combination of content including but not limited to text, images, graphic elements, graphs, videos, and so forth. As described further below, response area 212 may be swiped/scrolled vertically to view adjacent queries and responses that are part of the query playlist. In some embodiments, the response content is generated in real time for each of the queries in a playlist such as described below with reference to FIGS. 8C-8E. In some embodiments the response content is fixed per query such as but not limited to a tutorial playlist featuring queries (e.g.: “what is a bear market?”, “what are NFTs?”) and fixed “explainer” responses that may be textual, graphical, audio or video. In some implementations, query header 210 may not be displayed when a response is shown in response area 212;
a carousel indicator row 214 containing carousel dots 216 providing an indication of additional response areas 212 that may be viewed by interacting with response area 212 such as by swiping left or right to view additional horizontally arranged response areas;
a share button 218 for sharing the content of response area 212 with other users such as by providing a unique identifier to allow other users to access the same query and/or response;
a button or series of buttons 220 (only one is indicated in FIGS. 2A and 2C) for indicating a reaction to content of response area 212 such as but not limited to favoriting or un-favoriting or “pinning”;
a social media tags and identifiers area 221 for tagging the content of response area 212 with hashtags and/or associating the content of response area 212 with a user or organization, with the possible objective of providing a unique identifier to allow other users to access the same query;
a query posting box 222 for posting by a user (using text entry or voice entry) of a natural language conversational query directed to CQRP 110. Alternatively, a link 222 to a query posting box may be provided such as shown in FIGS. 2B and 2C; and
a menu bar 224 for accessing settings and other features associated with CQRP 110.

A user may interact with GUI 200 by user selection of the graphical elements of GUI 200. User selection of graphical elements may be performed using the interface hardware of user device 130. Non-limiting examples of user interaction performed by selection of graphical elements include, posting a query, browsing queries and response area content, liking response area content, sharing response area content, tagging response area content, associating response area content, and/or accessing settings and other features associated with CQRP 110.

Consistent with disclosed embodiments, at least one processor of the system may carry out operations that may involve outputting a signal for rendering a display of a natural language conversational AI view. The display of the natural language conversational AI view may include but is not limited to one or more of a query header 210, a response area 212, a carousel indicator row 214, a share button 218, a social media tags and identifiers area 222, a query posting box, and a menu bar 224. A signal may be any signal that may cause any action within CQRP 110. Rendering in this context refers to transforming code into visual representations for display. For example, a conversation interface may be displayed on a screen of a computing device as described herein. GUI 200 is an example implementation of a natural language conversational AI view, and it should be appreciated that other arrangements of the graphical elements (such as query header 210, a response area 212, and so forth) as well as additional/alternative graphical elements are contemplated, and the implementation of GUI 200 should not be considered limiting.

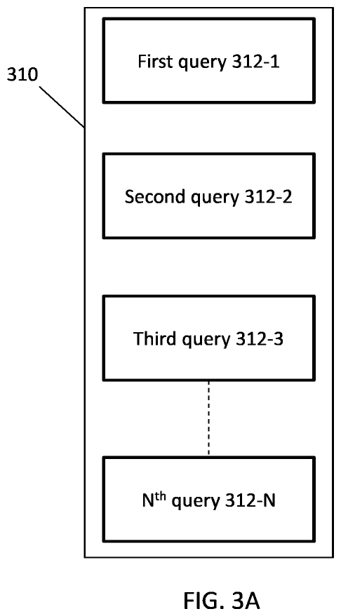

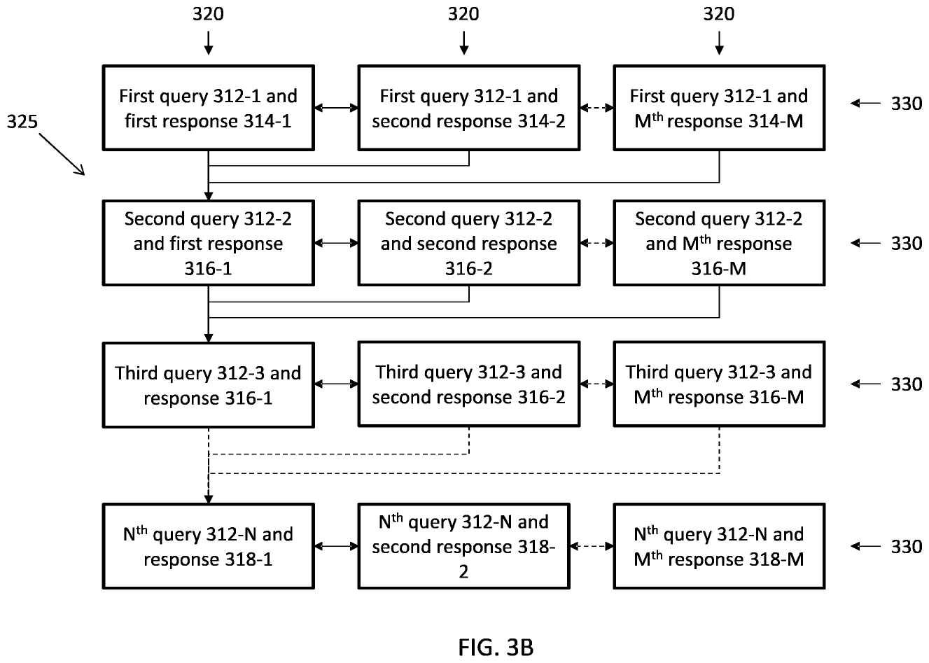

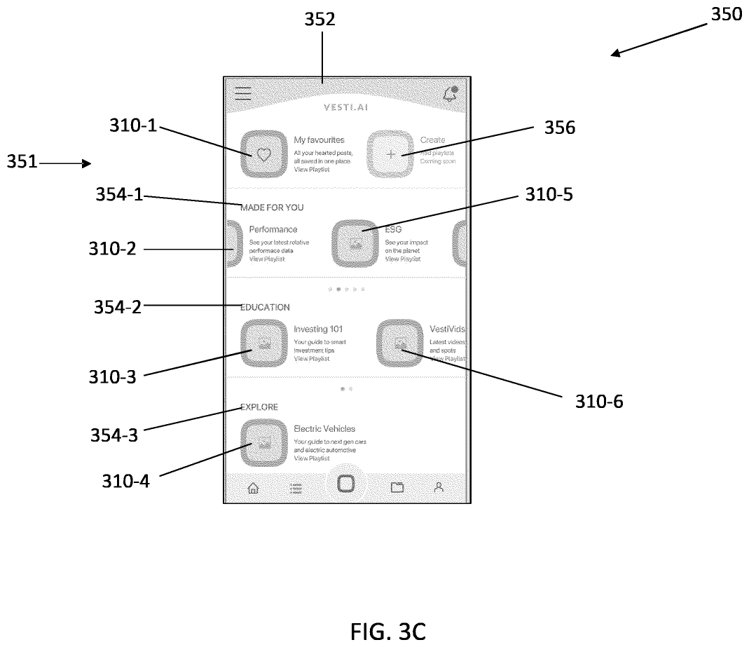

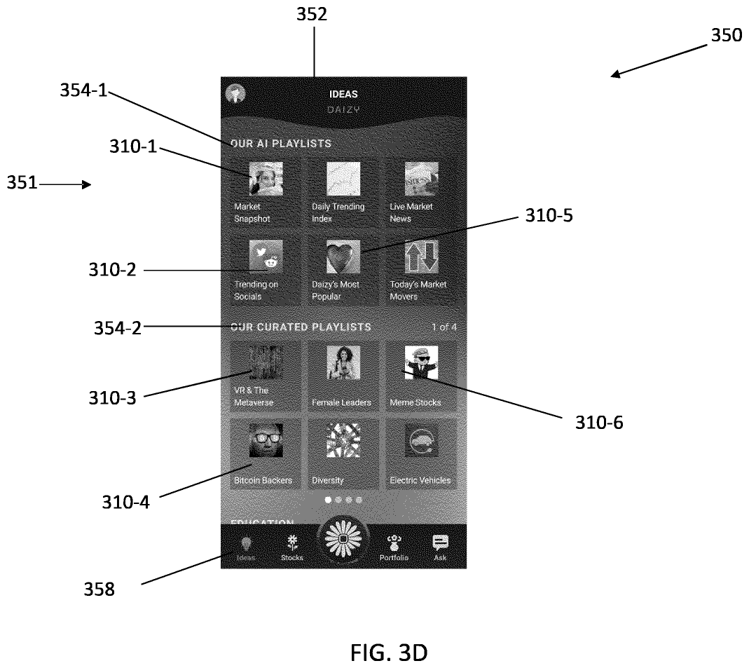

FIG. 3A is a diagram illustrating a query playlist, FIG. 3B is a diagram illustrating a query playlist flow and FIGS. 3C and 3D show an example GUI 350 for displaying a catalogue of query playlists consistent with some embodiments of this disclosure. A non-transitory computer readable medium may contain instructions that when executed by at least one processor, causes the at least one processor to prepare query playlist 310 for presentation in a GUI 136 of app 132 or browser 134 based on data provided, generated, or stored in CQRP 110 in response to the user posting a natural language conversational query, or alternatively in response to a user accessing GUI 136 such as by opening app 132 or accessing a website associated with GUI 136 via browser 134, or alternatively, a query playlist 310 may be selected from a catalogue 351 of query playlists 310 displayed via GUI 136 where the query playlists 310 are stored in CQRP 110 and/or on user device 130, or alternatively a playlist may be retrieved relating to a topic selected by a user. In some embodiments, the initial query 312-1 of query playlist 310 displayed to a user upon opening app 132 or accessing a website associated with GUI 136 via browser 134 or selecting a playlist may be generated by CQRP 110.

As shown in FIG. 3A, in some embodiments, such as when the response includes changing/dynamic data, a query playlist 310 stored in system 100 may include only a set of queries 312, where responses to each of the queries may be generated (formed into a presentable graphic and/or textual response by CQRP 110) while the user is browsing through the query playlist. FIG. 3A shows a query playlist 312 including multiple queries 312-1, 312-2, 312-3 and 312-N where N may be an integer. Thus, in some implementations, responses to the queries in a query playlist 310 may be generated when the query playlist 310 is selected. Alternatively, a response to a query may be generated as each query 312 is displayed to a user. Alternatively, in some implementations, a response to a query 312 may be generated when the query is the next query in line to be displayed or when a query 312 is within a predetermined number of queries that are in line to be displayed. A non-limiting example of dynamic/changing data includes stock prices where a most recent stock price may be required for formation of a response. In some implementations, where a query playlist 310 includes responses that are generally not dynamic, such as but not limited to a tutorial playlist with instructions for use of GUI 136, query playlist 310 may include a set of queries and pre-prepared responses.

As shown in FIG. 3B, in some implementations, a flow 325 of query-responses are provided for viewing in a combined vertical and horizontal arrangement, where vertically arranged query-responses 320 are accessible by scrolling or swiping up or down and horizontally arranged query-responses 330 are accessible by scrolling or swiping left or right. In some implementations, after a specified time period an adjacent vertical query-response may be presented to a user before a user has interacted with GUI 136.

In some implementations, vertical query-responses 320 are each based on different queries, here shown as queries 312-1, 312-2, 312-3 till 312-N. In some implementations, horizontal query-responses may be based on the same query 312 but may feature further information or a breakdown of the information presented in the first query-response. For example, as shown in FIG. 3B a first query 312-1 and first response 314-1 may be displayed. A user may swipe/scroll horizontally to view first query 312-1 and second response 314-2 to first query 312-1 and may continue to swipe/scroll horizontally to view first query 312-1 and M^{th} response 312-M to first query 312-1, where responses 314-2 to 314-M provide more information or a breakdown of the response 314-1 presented in query-response 312-1 and 314-1.

Alternatively, or additionally a user may swipe/scroll vertically to view second query 312-2 and first response 316-1 to second query 312-2 and may continue to swipe/scroll vertically to view third 312-3 and subsequent queries and related responses up to N^{th} query 312-N and first response 318-1 to N^{th} query 312-N. Although a limited number of query-responses are shown in FIG. 3B, it should be appreciated that any relevant number of queries may be added to query playlist 310 as a user browses through query playlist 310. Further, in some embodiments, query playlist 310 may be continually dynamically expanded or altered by CQRP 110 depending on the user behavior while swiping/scrolling through query playlist 310. In some implementations, query playlist 310 may be tailored to the user viewing the query playlist and features query-responses relevant to the user and/or may be based on queries asked by the user in previous sessions and/or queries asked by similar users.

In some implementations, a user may interrupt a query playlist 310 by posting a query, such as in query posting box 222. In addition to generating a response to the posted user query (the posted query may be shown in query header 210 and the response may be shown in response area 212), CQRP 110 may generate a new or revised query playlist 310 related to the posted user query.

In some implementations, system 100 may provide multiple query playlists 310 enabling a user to select a query playlist 310 of interest. FIGS. 3C and 3D show example GUI 350 for displaying a catalogue 351 of query playlists in view 352 according to an example implementation. GUI 350 may be prepared for presentation in a GUI 136 of app 132 or browser 134, for example, in response to a user selecting a “view query playlists” button (not shown) or “ideas” button 358.

In some embodiments, a query playlist 310 may be populated with content related to a user selected topic such that the user chooses a topic, rather than a playlist. In a non-limiting example, a user may choose a stock and app 132 or browser 134 will populate a “stock details” playlist with content according to one or more of the following queries: “stock summary”, “latest stock news”, “latest price line chart”, “stock recent performance”, “last 30 days performance bar chart”, “social media sentiment”, “social media activity”, “earnings history”, “analyst views”, “stock fundamentals”, stock risk analysis”, “stock market correlation”, “stock environmental, social and governance scores”, “stock sustainable development goal alignment”, “stock nutrition card”, and so forth.

In some implementations, such as shown in GUI 350, catalogue view 352 may include query playlists 310 generated by the user, such as query playlist 310-1 including queries that the user has “liked”, and/or query playlists 310 generated by CQRP 110 such as query playlists 310-2, 310-3, 310-4, 310-5, and 310-6. In some implementations, query playlists 310 are displayed in catalogue view 352 within query playlist categories 354. In some implementations, query playlist categories 354 are created by CQRP 110 and query playlists 310 are added to the created categories. Alternatively or additionally, query playlist categories may be created by a user and query playlists 310 are added to the created categories 354. In some implementations, a user may select a “create query playlist” button such as button 356 for defining a set of queries in the created query playlist 310. Upon selection of a query playlist 310 from catalogue view 352, the selected query playlist 310 may be displayed as described above with reference to FIG. 3B including retrieval/generation of the responses to the queries in the query playlist.

In some implementations, where a user has viewed all of the query-responses in a query playlist 310, CQRP will generate additional queries and responses such that the user may continue to view a query playlist 310. In some implementations, where a user has viewed all of the query-responses in a query playlist 310, the user will be returned to the query playlist catalogue view 352 for selection of another query playlist 310.

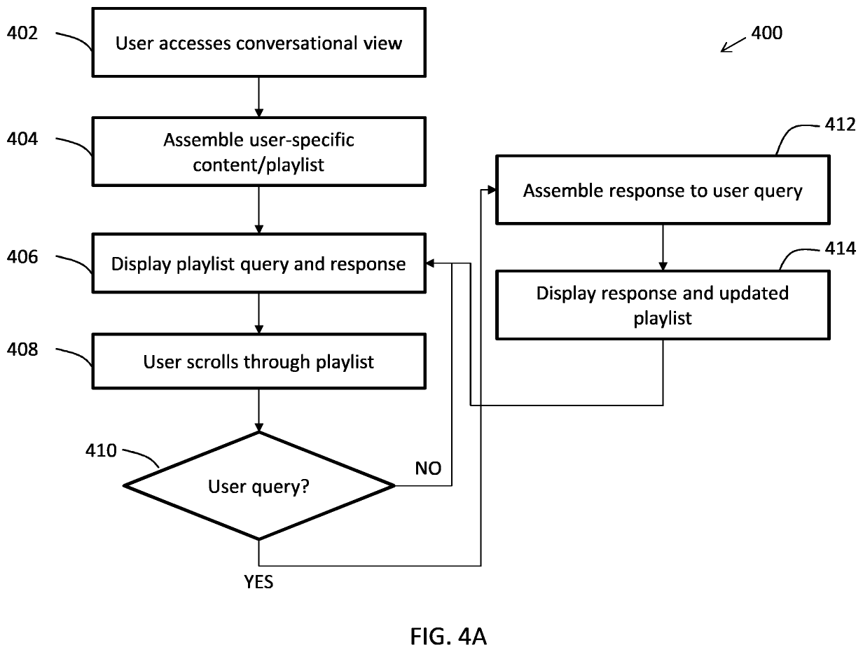

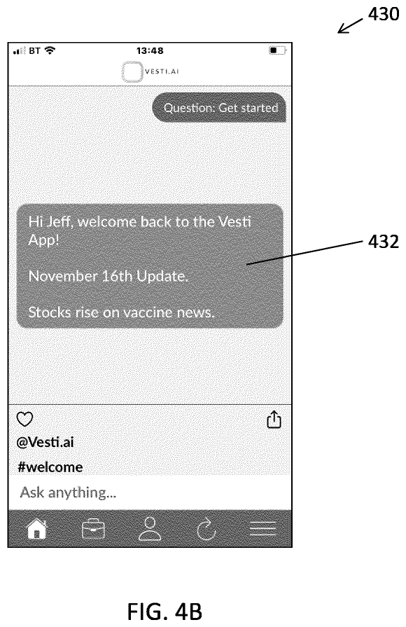

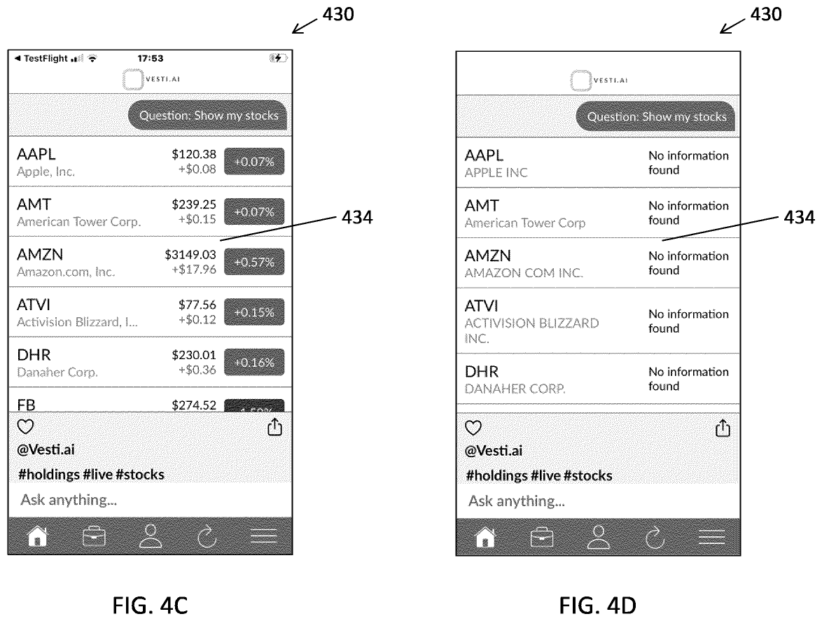

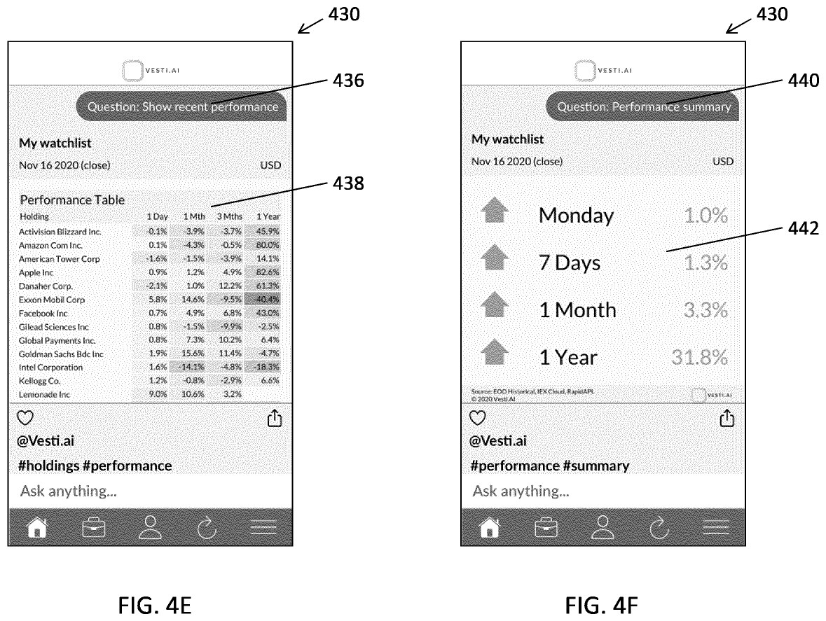

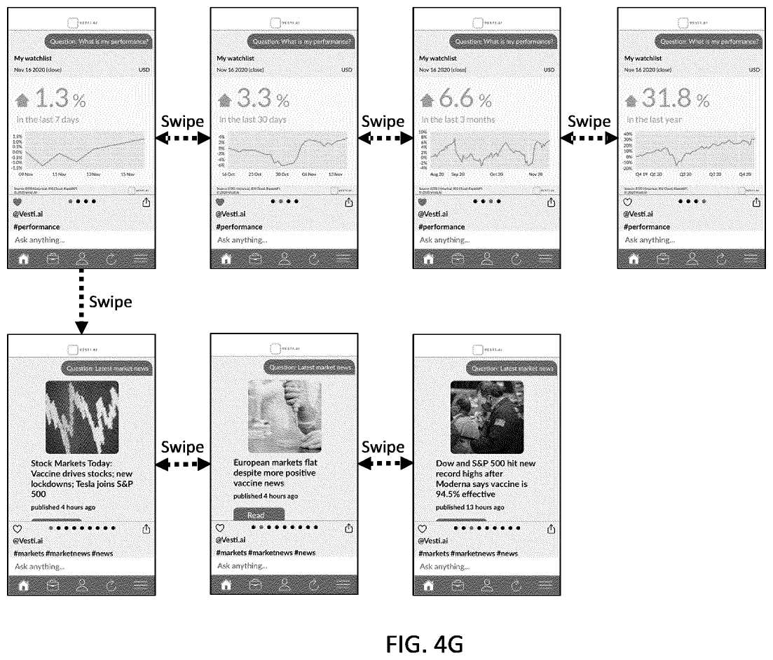

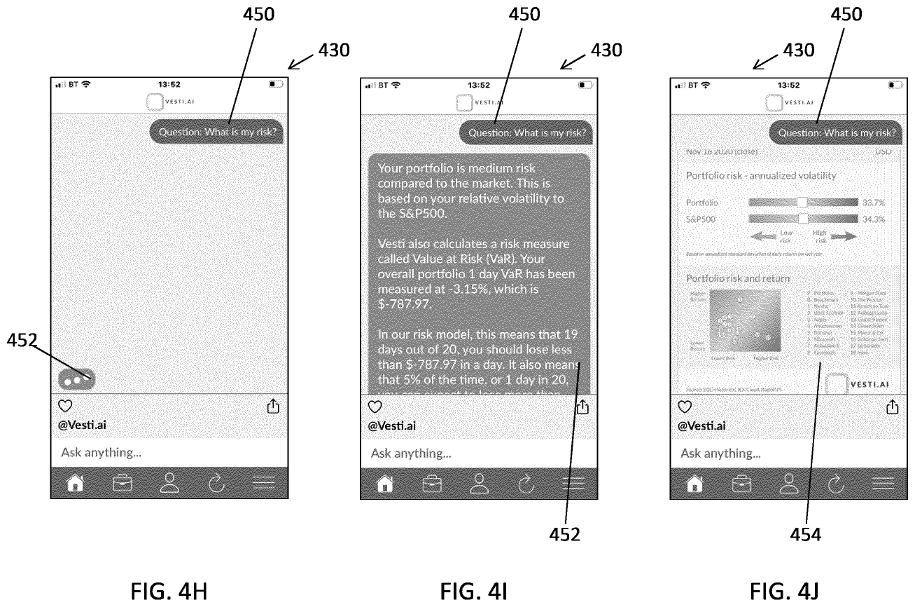

FIG. 4A is a diagram of an example process 400 for displaying a natural language conversational view consistent with some embodiments of this disclosure. This process 400 may for example be performed by system 100 as described above. FIGS. 4B-4J illustrates example graphical user interfaces 430 for displaying a natural language conversational view consistent with some embodiments of this disclosure. A non-transitory computer readable medium may contain instructions that when executed by at least one processor performs the operations described at each step in process 400. The at least one processor may correspond to CQRP 110 and/or user device 130. GUI 430 is an illustrative embodiment of GUI 200 described above with reference to FIGS. 2A-2C. In the examples below, the conversational AI platform is used to provide financial/investing related data, but it should be appreciated that the platform and process 400 as described herein may be used in other fields and the system as described is not limited to financial/investing related data. Where process 400 refers to operation of CQRP 110 this should be understood as referring to operation of the components of CQRP 110 that may be controlled by controller service 114.

At block 402, a user accesses a conversation view such as shown in FIG. 4A. The accessing may be performed by opening app 132 or directing browser 134 to the web address of the provider of the conversational AI such as web server 112. As shown in FIG. 4B, GUI 430 displays a welcome message 432.

In step 404, app 132 or browser 134 may send the user ID to CQRP 110 which may identify the user, retrieve the user portfolio (such as stocks being held/watched) and then assemble a query playlist as well as responses based on one or more of an analysis of the portfolio and/or queries asked by the user in previous sessions and/or queries asked by similar users. Non-limiting examples of queries for which responses are prepared include: “show my stocks”, “what is the historic pricing of a stock?”, “what is the value of my portfolio?”, “what's new?”, “explain the terms ESG”, and “what is the performance/risk/ESG of my portfolio and individual stocks held?” In some implementations, the query playlist will be displayed vertically. In some implementations, the query playlist will be displayed horizontally. In some implementations, the query playlist will be displayed in a combination of vertically and horizontally such as shown in FIG. 3B described above. In some implementations, an initial view presented to a user will be a query playlist catalogue view 352 such as shown in FIG. 3C. Selection of a query playlist 310 to view will display the first query in the query playlist as in step 406.

In step 406, the first query of the query playlist may be displayed along with the response. As shown in FIGS. 4C and 4D, in response to the query playlist query “show my stocks”, a listing 434 of stocks may be provided. FIG. 4C shows listing 434 when stock data is available and FIG. 4D shows listing 434 when no stock data is available such as when stocks are not trading. In some implementations, to display the response shown in FIG. 4C, analytics service 122 may query external services 150 for data. External services 150 may provide current prices and pricing history of each stock in the portfolio for differing time periods, analytics service 122 may then arrange and transmit the obtained results of the query to the infographic service 124. Infographic service 124 may then prepare the content (listing 434) for presenting in response area 212. In some implementations, content prepared by infographic service 124 may be stored on CQRP 110 such as in data repository 120 for retrieval by app 132 or browser 134 for display in response area 212.

In step 408, a second and subsequent query and related response of the query playlist may be viewed by scrolling up and/or down (vertical query playlist) and/or left and right (horizontal query playlist). As shown in FIG. 4E, a second query “show recent performance” and related response of the query playlist may be displayed after, for example, swiping up by a user along with a prepared response 438. As shown in FIG. 4F, a third query “Performance summary” of the query playlist of queries 440 along with a prepared response 442 may be displayed after, for example, swiping up by a user.

As shown in FIG. 4G, in response to the query “what is my performance” carousel indicator row 214 shows additional response areas 212 that may be viewed by interacting with response area 212 such as by swiping left or right to view additional response areas. Additionally and alternatively a user may swipe up and down to view other queries in the query playlist. As shown in FIG. 4G, swiping down shows the queries “Latest market news”, with further carousel responses to the same query available by swiping left and right.

Advantageously, the user may thus be exposed to different queries that CQRP 110 can respond to so that the user may understand the scope of queries that can be asked and pose these queries in the future or simply rely on a useful query playlist and thus use the system more extensively.

The user behavior while scrolling through the vertical/horizontal query playlist and responses may be monitored by app 132 or browser 134 and transmitted to CQRP 110 for analysis. Based on this analysis, the order of queries in the query playlist or future query playlists are adjusted based on multiple user behavior factors including but not limited to likes, saves, time spent on screens, number of carousel posts viewed, and questions asked (step 410). Queries can then be prioritized in the query playlist for the user so that, advantageously, the content becomes more relevant and engaging based on usage and interaction.

In step 410, Where no query is posted by the user, the query playlist will continually be updated and expanded upon. Alternatively, in step 410 a user may post a query such as by typing a query in query posting box 222 or by verbally speaking the query. The posted query may then be shown in query header 210. As shown in FIG. 4H, in response to the query 450 “What is my risk”, GUI 400 will display some form of indication 452 to the user that the query is being processed.

In step 412, the user query may be transmitted to CQRP 110 and a response to the user query may be formulated as follows. In some implementations, conversational AI service 116 analyses the query to further train conversational AI service 116 to better anticipate the queries that users may ask. In some implementations, natural language service 118 recognizes speech and text inputs and deconstructs the recognized text to extract a user intent, context and also time period. In some implementations, analytics service 122 may query external services 150 for current prices and pricing history of each stock in the portfolio for differing time periods, analytics service 122 may then arrange and transmit the obtained results of the query to the infographic service 124. Infographic service 124 may then prepare the content (text data 452 and infographic 454) for presenting in response area 212.

In step 414, the prepared responses, text data 452 (FIG. 4I) and infographic 454 (FIG. 4J) are displayed to the user in response to the posted user query such that a user may view text data 452 and then swipe up to view infographic 454. Process 400 then returns to step 406, displaying the query playlist for the user to scroll through where the query playlist may include updated queries based on the posted query. Further, in some embodiments (such as shown in FIG. 8F below), the playlist being viewed may include a suggested list 841 of related topics and/or playlists. In some embodiments, suggested list 841 may be generated in CQRP 110 using machine learning based analysis of the queries and playlists that have been previously selected by the user. Advantageously, such a suggested list may introduce users to other topics and playlists that may be provided by system 100.

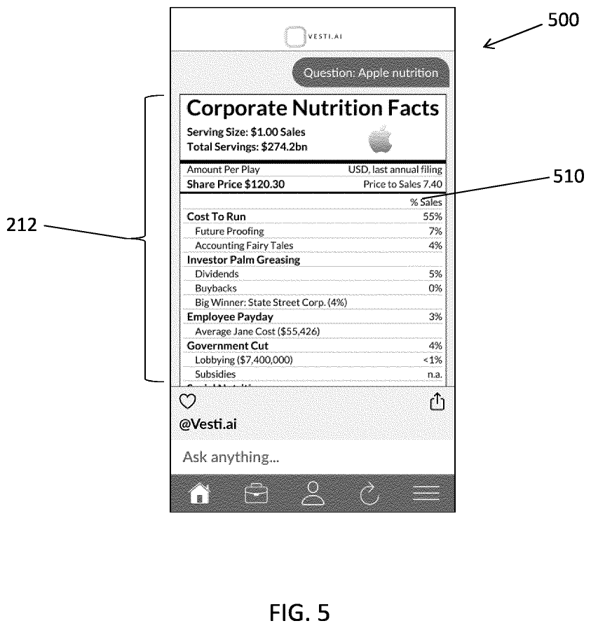

FIG. 5 illustrates an example graphical user interface 500 for characterizing financial data consistent with some embodiments of this disclosure. A non-transitory computer readable medium may contain instructions that when executed by at least one processor causes GUI 500 to be displayed such as in response to a query about “corporate nutrition”. As shown in FIG. 5, GUI 500 includes an image 510 in response area 212, the image summarizing data related to a company or business. Image 510 may be displayed such as in response to a query about the financial data of a company or business. In GUI 500, the query relating to the financial data may be termed the “corporate nutrition” of the company or business.

As shown, the company financial data may be displayed in a format in image 510 that mimics the layout and look and feel of a “standard vertical” food nutrition label as defined by the US Food and Drug Administration (FDA) including but not limited to fonts, font sizes, lines, line thicknesses, borders, and so forth. As shown in FIG. 5, the label content relates to company financial data and so uses related terminology. The FDA food label guidelines that are mimicked by image 510 titled “Corporate Nutrition Facts” are specified for example by the FDA at the following link: https://www.regulations.gov/document?D=FDA-2012-N-1210-0875 hereby included by reference in its entirety as if fully set forth herein. Reference herein to a standard vertical food nutrition label should be understood as referring to the standard vertical food nutrition label regulated in the above FDA regulations.

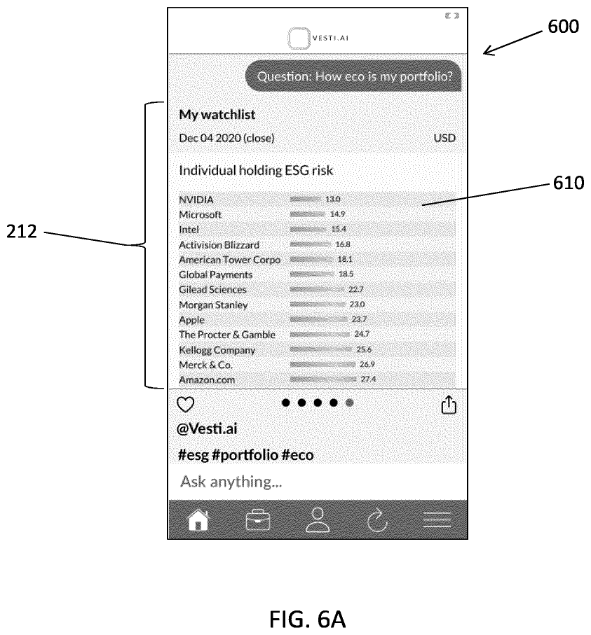

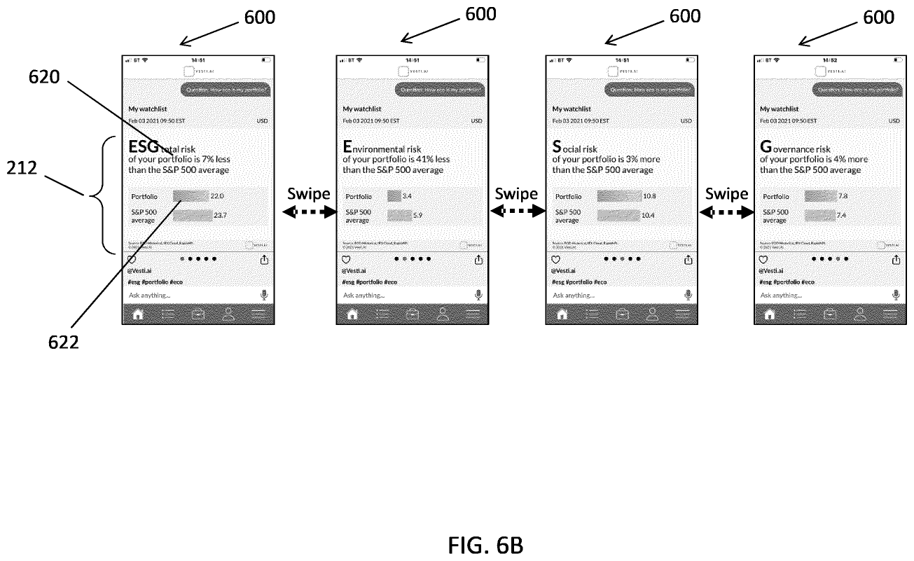

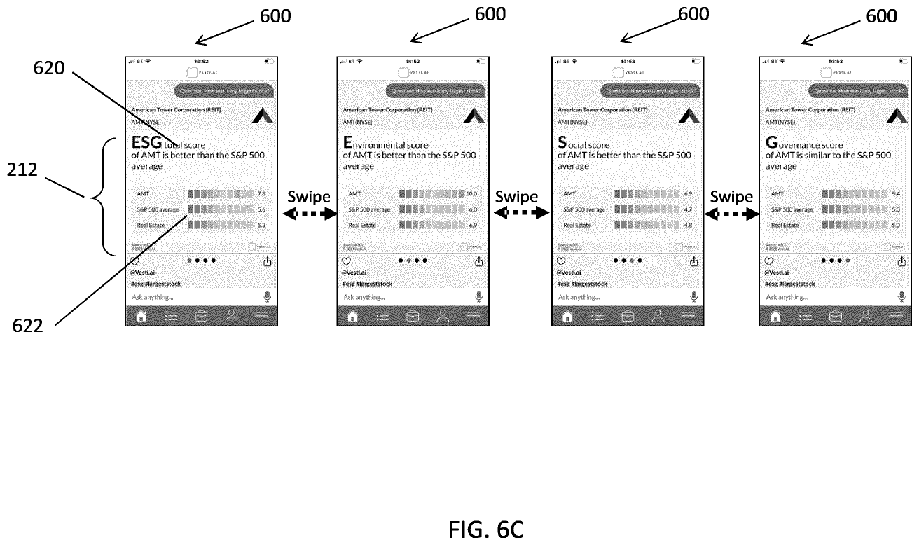

FIGS. 6A and 6B illustrate an example graphical user interface 600 for characterizing financial data consistent with some embodiments of this disclosure. A non-transitory computer readable medium may contain instructions that when executed by at least one processor causes a GUI 600 to be displayed such as in response to a user posting a query asking about the environmental, social, and corporate governance (ESG) of the user portfolio to thereby gauge the sustainability and societal impact of the portfolio. As shown in FIG. 6A, GUI 600 includes a bar graph 610 in response area 212, the image summarizing ESG data of a user portfolio with a gradient color scheme and list of companies arranged in order of ESG scoring thus providing an accessible visual indication of the relative ESG ranking of the companies.

In FIG. 6B, showing four presentations of GUI 600 accessed by swiping/scrolling horizontally in response to the same query, specific parameters of ESG are analyzed and compared to a known index. In FIG. 6C, showing four presentations of GUI 600 accessed by swiping/scrolling horizontally in response to a similar ESG query about a specific stock, specific parameters of ESG are analyzed and compared to a known index. In GUI 600 as shown in FIGS. 6B and 6C, a textual portion 620 of response area 212 provides a clear explanation of the ESG parameter versus the chosen index. In some implementations, the ESG average for the chosen index may be determined by CQRP 110 by retrieving ESG data for individual companies and then using analytics service to calculate an average ESG for the index. In some implementations, the portfolio or company ESG may be compared with the ESG of a specific market sector by similarly retrieving ESG data for representative stocks in the chosen sector and determining an average ESG for the sector. A graphical comparison 622 may also be provided in a portion of response area 212 for illustrating the ESG parameter versus the chosen index. It should be appreciated that the representations of FIGS. 6A-6C are designed to make ESG financial data more accessible and understandable to all types of investors.

FIGS. 7A-7C illustrate an example graphical user interface 700 for characterizing financial data consistent with some embodiments of this disclosure. A non-transitory computer readable medium may contain instructions that when executed by at least one processor causes a GUI 700 to be displayed such as in response to a query about the risk related to a user portfolio or specific stock. As shown in FIG. 7A, GUI 700 includes a colored gradient square 710 with the portfolio stocks mapped onto the square to visually indicate the relative risk of each stock.

In FIG. 7B, showing GUI 700 accessed by swiping/scrolling horizontally in response to the same query, a “slider” view 720 provides a visual indication of annualized volatility of a user portfolio compared to an index or benchmark. In FIG. 7C, GUI 700, accessed by swiping/scrolling horizontally in response to a similar query, shows risk data for a specific stock compared to a known index. In GUI 700 as shown in FIG. 7C, a textual portion 730 of response area 212 provides a clear explanation of the stock risk versus the chosen index. A graphical comparison may be also provided using the gradient square 732 or bar graph 734 over time in a portion of response area 212 for illustrating the stock risk versus the chosen index. It should be appreciated that the representations of FIGS. 7A-7C are designed to make financial risk data more accessible and understandable to all types of investors.

FIG. 8A is a diagram of an example process 800 for displaying a playlist view consistent with some embodiments of this disclosure. This process 800 may for example be performed by system 100 as described above. FIGS. 8B-8G illustrate example graphical user interfaces 822 for selecting and displaying playlist views consistent with some embodiments of this disclosure. The steps of process 800 are described with reference to a non-transitory computer readable medium containing instructions that when executed by at least one processor performs operations described at each step. The at least one processor may correspond to CQRP 110 and/or user device 130. GUI 822 is an illustrative embodiment of GUI 200 described above with reference to FIGS. 2A-2C.

In the examples below, the conversational AI platform is used to provide financial/investing related data, but it should be appreciated that the platform and process 800 as described herein may be used in other fields and the system as described is not limited to financial/investing related data. Where process 800 refers to operation of CQRP 110 this should be understood as referring to operation of the components of CQRP 110 that may be controlled by controller service 114.

In step 802, a user selects a query playlist 820 from a playlist catalogue (FIG. 8B) or alternatively chooses a topic 830 (FIG. 8C) (in this case the ticker of a currency or stock or coin or other financial instrument) or alternatively chooses a user portfolio 831 (FIG. 8G) to thereby generate a topic-related playlist such as shown in FIGS. 8D and 8E. In some embodiments, a user may choose the topic of a combined portfolio where the financial data from multiple portfolios 831 may be combined and used for populating the responses of a playlist.

In step 804, app 132 or browser 134 may request the playlist or request the playlist related to a selected topic from CQRP 110 which may identify the user, retrieve the playlist queries, and then populate the playlist in real time with responses to the queries of the playlist according to the topic. In some embodiments, CQRP 110 provides the data and optionally formatting guidelines where app 132 or browser 134 assemble the received data into the displayed form. Non-limiting examples of queries for which responses may be prepared in real time related to the topic (where non-limiting examples of a topic may be a stock, portfolio, market segment, investment type, and so forth) include: “stock summary”, “latest stock news”, “latest price line chart”, “stock recent performance”, “last 30 days performance bar chart”, “social media sentiment”, “social media activity”, “earnings history”, “analyst views”, “stock fundamentals”, stock risk analysis”, “stock market correlation”, “stock environmental, social and governance scores”, “stock United Nations sustainable development goal alignment”, “stock nutrition card”, and so forth. Alternatively, for playlists with fixed responses to the playlist queries, the queries and preprepared responses may be retrieved by app 132 or browser 134 for display. In some embodiments, playlists for display may be stored, populated, and presented on user devices 130.

In step 806, the first query 832 of the playlist may be displayed along with the response. As shown in FIGS. 8D and 8E, a user has selected the topic of “AAPL” (the stock), and the “deep dive” playlist has been generated in response. The first query 832 on the playlist is “stock summary card”. In some implementations, to display the response shown in FIGS. 8D and 8E, analytics service 122 may query external services 150 for data in real time. External services 150 may provide current prices, pricing history, social media sentiment, ESG data and so forth for the stock chosen as the topic of the playlist. Analytics service 122 may then arrange and transmit the obtained results of the query to the infographic service 124. Infographic service 124 may then prepare the content for presenting in the response area 836, 840. In some implementations, content prepared by infographic service 124 may be stored on CQRP 110 such as in data repository 120 for retrieval by app 132 or browser 134 for display in response areas 836, 840.

In step 808, a second and subsequent query 838 and related response of the playlist may be viewed by scrolling up and/or down (vertical query playlist) and/or left and right (horizontal query playlist). As shown in FIG. 8E, a second query 838 “AAPL recent performance” and related response 840 may be displayed after, for example, swiping up by a user.

As shown in FIG. 8E, carousel indicator row 834 shows additional response areas that may be viewed by interacting with response area 840 such as by swiping left or right to view additional response areas. Additionally and alternatively a user may swipe up and down to view other queries and related responses in the query playlist.

Advantageously, the user may thus be exposed to different queries that CQRP 110 can respond to so that the user may understand the scope of queries that can be asked and pose these queries in the future or simply rely on a useful playlist and thus use the system more extensively.

The user behavior while scrolling through the vertical/horizontal playlist and responses may be monitored by app 132 or browser 134 and transmitted to CQRP 110 for analysis. Based on this analysis, the order of queries in the playlist or future query playlists are adjusted based on multiple user behavior factors including but not limited to likes, saves, time spent on screens, number of carousel posts viewed, and questions asked (step 410 above). Queries can then be prioritized in the playlist for the user so that, advantageously, the content becomes more relevant and engaging based on usage and interaction. Further, in some embodiments (FIG. 8F), in step 810, the playlist being viewed (initiated from playlists 820 or topics 830) may include a suggested list 841 of related topics and/or playlists. In some embodiments, suggested list 841 may be generated in CQRP 110 using machine learning based analysis of the topics and playlists that have been previously selected by the user. Advantageously, such a suggested list may introduce users to other topics and playlists that may be provided by system 100.

The following examples pertain to further embodiments disclosed herein.

Example 1 is a machine readable non-transitory storage medium having instructions stored thereon, wherein the instructions, when executed by at least one processor, cause the at least one processor to perform operations including: displaying a graphical user interface including a query header with a query therein and a response area displaying a response to the displayed query; and providing for display, a query playlist of further queries and related responses arranged vertically and/or horizontally.

Example 2 may include the subject matter of Example 1 and may further specify that the operations further include: displaying a query entry box; where a query is entered by a user, adding the query to the query playlist; displaying the query in the query header; and displaying a response to the query in the response area.

Example 3 may include the subject matter of Examples 1 and 2 and may further specify that the operations further include: preparing by a conversational management platform of the response to the query.

Example 4 is a system including: a user device including an app and/or a browser configured for presenting a GUI; and a controller service configured for receiving a query entered into the GUI and providing a response for presentation on the GUI, or for providing a query playlist for presentation in the GUI when no query is entered into the GUI.

Example 5 may include the subject matter of example 4, and further include a natural language service configured for providing speech recognition and natural language processing of queries entered into the GUI.

Example 6 may include the subject matter of example 5, and further include an AI playlist service configured for analyzing a query entered into the GUI and for adapting the query playlist according to the query.

Example 7 may include the subject matter of example 6, and further include an analytics service configured for providing data required in the response to the query.

Example 8 may include the subject matter of example 7, and further include an infographic service configured for generation of graphical representations of the provided data for presentation in the GUI in response a query.

Example 9 may include the subject matter of example 8, wherein the query playlist includes queries and related responses arranged for vertical and/or horizontal presentation in the GUI.

Example 10 may include the subject matter of example 8, wherein the query playlist is one of a catalogue of query playlists.

Example 11 is a machine readable non-transitory storage medium having instructions stored thereon, wherein the instructions, when executed by at least one processor, cause the at least one processor to perform operations including: displaying an infographic in a graphical user interface, the infographic including financial data related to a company or business, wherein the infographic is configured to mimic the layout and look and feel of a food nutrition label.

Unless otherwise defined, all technical and scientific terms used herein have the same meaning as commonly understood by one of ordinary skill in the art. The materials, methods, and examples provided herein are illustrative only and not intended to be limiting.

As used herein the terms “machine learning” or “artificial intelligence” refer to use of algorithms on a computing device that parse data, learn from the data, and then make a determination or generate data, where the determination or generated data is not deterministically replicable (such as with deterministically oriented software as known in the art).

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1-34. (canceled)

35. A method for generating a conversational presentation, comprising: in response to a natural language conversational user query relating to financial information, providing for display on a graphical user interface (GUI) a response to the user query and a suggested playlist of queries.

36. The method of claim 35, further comprising generating of a graphical representation of financial information for presentation in the GUI as part of the response to the user query.

37. The method of claim 35, wherein the response to the user query and/or suggested playlist of queries are related to a user financial portfolio.

38. The method of claim 35, further comprising displaying on the GUI the suggested playlist of queries and related responses arranged in a scrollable vertical and horizontal display.

39. The method of claim 38, wherein the related responses include predefined responses or real-time responses.

40. The method of claim 35, further comprising performing speech recognition and natural language processing of the user query to extract at least one of a user intent, a context, and a time period; and providing the response to the user query based on analysis of the at least one of user intent, context, and time period.

41. The method of claim 35, further comprising providing suggestions for other queries and/or playlists that may interest the user following machine learning based analysis of the user query.

42. The method of claim 35, further comprising, in response to a user selecting a financial topic of interest, providing a query playlist adapted to the financial topic of interest.

43. The method of claim 35, wherein the suggested playlist of queries relates to financial market data and include at least one of ESG (environmental, social, and corporate governance), social media sentiment, social media activity, alignment with UN sustainable development goals, corporate nutrition facts, and a morality scorecard.

44. The method of claim 36, wherein the graphical representation of financial information includes financial data related to a company or business in a presentation that mimics the layout of a food nutrition label.

45. A system comprising at least one processor configured to provide for display on a graphical user interface (GUI) a response to a natural language conversational user query relating to financial information and a suggested playlist of queries related to the user query.

46. The system of claim 45, wherein the at least one processor is further configured to generate a graphical representation of financial information for presentation in the GUI as part of the response to the user query.

47. The system of claim 45, wherein the response to the user query and/or suggested playlist of queries are related to a user financial portfolio.

48. The system of claim 45, wherein the at least one processor is further configured to display on the GUI the suggested playlist of queries and related responses arranged in a scrollable vertical and horizontal display.

49. The system of claim 48, wherein the related responses include predefined responses or real-time responses.

50. The system of claim 45, wherein the at least one processor is further configured to perform speech recognition and natural language processing of the user query to extract at least one of a user intent, a context, and a time period; and providing the response to the user query based on analysis of the at least one of user intent, context, and time period.

51. The system of claim 45, wherein the at least one processor is further configured to provide suggestions for other queries and/or playlists that may interest the user following machine learning based analysis of the user query.

52. The system of claim 45, wherein the at least one processor is further configured, in response to a user selecting a financial topic of interest, to provide a query playlist adapted to the financial topic of interest.

53. The system of claim 45, wherein the suggested playlist of queries relates to financial market data and include at least one of ESG (environmental, social, and corporate governance), social media sentiment, social media activity, alignment with UN sustainable development goals, corporate nutrition facts, and a morality scorecard.

54. The system of claim 46, wherein the graphical representation of financial information includes financial data related to a company or business in a presentation that mimics the layout of a food nutrition label.
